(19) United States
(12) Patent Application Publication
(10) Pub. No.: US 2024/0204361 A1
(43) Pub. Date: Jun. 20, 2024

(54) LITHIUM ION BATTERY MATERIAL HANDLING VEHICLE

(71) Applicant: Toyota Material Handling, Inc., Columbus, IN (US)

(72) Inventors: Jeffrey Fritsch, Columbus, IN (US); Zhong Shi, Columbus, IN (US); Gerard Pedraja, Columbus, IN (US)

(21) Appl. No.: 18/540,489

(22) Filed: Dec. 14, 2023

Related U.S. Application Data
(60) Provisional application No. 63/387,346, filed on Dec. 14, 2022.

(51) Int. Cl. H01M 50/505; H01M 50/503

(52) U.S. Cl. CPC H01M 50/505; H01M 50/503; H01M 2220/20

(57) ABSTRACT

A battery powered material handling vehicle with a battery pack. A busbar can be provided to equally distribute charging current within the battery pack.

### BACKGROUND

Conventional material handling vehicles are useful in a variety of indoor and outdoor environments. In particular, material handling vehicles are useful for lifting, lowering, and moving various loads from one location to another. Conventional material handling vehicles are powered by a combustion engine for vehicle movement. In some applications, batteries have been used to provide power to the motors responsible for moving the vehicle forward and backward. Lead-acid batteries can be used, but lead-acid batteries can lose output power as the charge depletes, take a long time to charge, and require maintenance such as watering. In some instances, this can create a need for a second set of batteries such that one set of batteries is in use while the second set is charging.

Lithium-ion batteries, on the other hand, provide more consistent power delivery, faster charging speeds, allow for opportunity charging, and require less maintenance. However, adapting lithium-ion batteries for use in material handling vehicles presents a number of design considerations. For example, because lithium-ion batteries include a battery management system, additional hardware and software can be required to integrate the lithium-ion batteries into the vehicle control system. Also, temperature control of the battery and/or other vehicle components, may need to be considered due to the different heating/cooling properties of lithium-ion batteries. Therefore, it would be useful to provide an improved material handling vehicle design that provides advantages over the existing art.

### SUMMARY

Some embodiments provide a busbar for a battery pack, the busbar including a first system-side terminal, a second system-side terminal, a first battery-side terminal, a second battery-side terminal, a first electric current pathway, a second electric current pathway, a third electric current pathway, and a fourth electric current pathway. The first electric current pathway has a first length value defined from the first system-side terminal to the first battery-side terminal. The second electric current pathway has a second length value defined from the first system-side terminal to the second battery-side terminal. The third electric current pathway has a third length value defined from the second system-side terminal to the first battery-side terminal. The fourth electric current pathway has a fourth length value defined from the second system-side terminal to the second battery-side terminal. A first sum value of the first length value and the second length value is substantially equal to a second sum value of the third length value and the fourth length value.

In some forms, the busbar further includes a third battery-side terminal. The busbar can include a fifth electric current pathway having a fifth length value defined from the first system-side terminal to the third battery-side terminal. The busbar can include a sixth electric current pathway having a sixth length value defined from the second system-side terminal to the third battery-side terminal. A third sum value can be defined by the sum of the first sum value and the fifth length value. A fourth sum value can be defined by the sum of the second sum value and the sixth length value. The third sum value can be substantially equal to the fourth sum value. The first electric current pathway, the second electric current pathway, the third electric current pathway, and the fourth electric current pathway can all be formed of the same material.

Some embodiments provide a busbar for a battery pack, the busbar including a core busbar body including a first system-side terminal and a second system-side terminal, a first busbar leg connected to the core busbar body and including a first battery-side terminal, and a second busbar leg connected to the core busbar body and including a second battery-side terminal. A first length value is defined along the core busbar body and the first busbar leg from the first system-side terminal to the first battery-side terminal. A second length value is defined along the core busbar body and the second busbar leg from the first system-side terminal to the second battery-side terminal. A third length value is defined along the core busbar body and the first busbar leg from the second system-side terminal to the first battery-side terminal. A fourth length value is defined along the core busbar body and the second busbar leg from the second system-side terminal to the second battery-side terminal. A first sum value of the first length value and the second length value is substantially equal to a second sum value of the third length value and the fourth length value.

In some forms, the busbar includes a third busbar leg connected to the core busbar body and including a third battery-side terminal. A fifth length value can be defined along the core busbar body and the third busbar leg from the first system-side terminal to the third battery-side terminal. A sixth length value can be defined along the core busbar body and the third busbar leg from the second system-side terminal to the third battery-side terminal. A third sum value can be defined by the sum of the first sum value and the fifth length value. A fourth sum value can be defined by the sum of the second sum value and the sixth length value. The third sum value can be substantially equal to the fourth sum value. The core busbar body, the first busbar leg, the second busbar leg, and the third busbar leg can all be formed of the same material.

Some embodiments provide a busbar for a battery pack, the busbar including a core busbar body including a system-side terminal, a first busbar leg connected to the core busbar body and including a first battery-side terminal, a second busbar leg connected to the core busbar body and including a second battery-side terminal, and a third busbar leg connected to the core busbar body and including a third battery-side terminal. A first length value is defined along the core busbar body and the first busbar leg from the system-side terminal to the first battery-side terminal. A second length value is defined along the core busbar body and the second busbar leg from the system-side terminal to the second battery-side terminal. A third length value is defined along the core busbar body and the third busbar leg from the system-side terminal to the third battery-side terminal. The first length value, the second length value, and the third length value are all substantially equal.

In some forms, the first busbar leg, the second busbar leg, and third busbar leg are each connected to the core busbar body at an angle. The angle can be 90 degrees. The core busbar body, the first busbar leg, the second busbar leg, and the third busbar leg can each be provided in the form of one or more rectilinear shapes.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is a side elevational view of a material handling vehicle according to an embodiment;

FIG. 2 is a partial top isometric view of a battery pack of the material handling vehicle of FIG. 1 with some elements rendered transparently for clarity;

FIG. 3 is a top isometric view of a busbar according to one embodiment;

FIG. 4 is a bottom isometric view of the busbar of FIG. 3;

FIG. 5A is a top plan view of the of the busbar of FIG. 3 in a flattened form illustrating various dimensional aspects;

FIG. 5B is another top plan view of the of the busbar of FIG. 3 in a flattened form illustrating various additional dimensional aspects;

FIG. 6 is a front view of a display module for use with the material handling vehicle of FIG. 1;

FIG. 7 is a block diagram of a network to which the material handling vehicle of FIG. 1 is connected according to an embodiment;

FIG. 8A is a graph of torque limit reduction versus temperature for a torque limiting function of the material handling vehicle of FIG. 1; and

FIG. 8B is a graph of top speed limit reduction versus temperature for a speed limiting function of the material handling vehicle of FIG. 1.

### DETAILED DESCRIPTION

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize that the examples provided herein have many useful alternatives and fall within the scope of embodiments of the invention.

Before any embodiments of the invention are explained in detail, it is to be understood that the invention is not limited in its application to the details of construction and the arrangement of components set forth in the following description or illustrated in the attached drawings. The invention is capable of other embodiments and of being practiced or of being carried out in various ways. Also, it is to be understood that the phraseology and terminology used herein are for the purpose of description and should not be regarded as limiting. For example, the use of “including,” “comprising,” or “having” and variations thereof herein is meant to encompass the items listed thereafter and equivalents thereof as well as additional items.

As used herein, unless otherwise specified or limited, the terms “mounted,” “connected,” “supported,” and “coupled” and variations thereof are used broadly and encompass both direct and indirect mountings, connections, supports, and couplings. Further, unless otherwise specified or limited, “connected” and “coupled” are not restricted to physical or mechanical connections or couplings but can also refer to communicative, electrical, or fluidic couplings.

As used herein, unless otherwise specified or limited, “at least one of A, B, and C,” and similar other phrases, are meant to indicate A, or B, or C, or any combination of A, B, and/or C. As such, this phrase, and similar other phrases can include single or multiple instances of A, B, and/or C, and, in the case that any of A, B, and/or C indicates a category of elements, single or multiple instances of any of the elements of the categories A, B, and/or C.

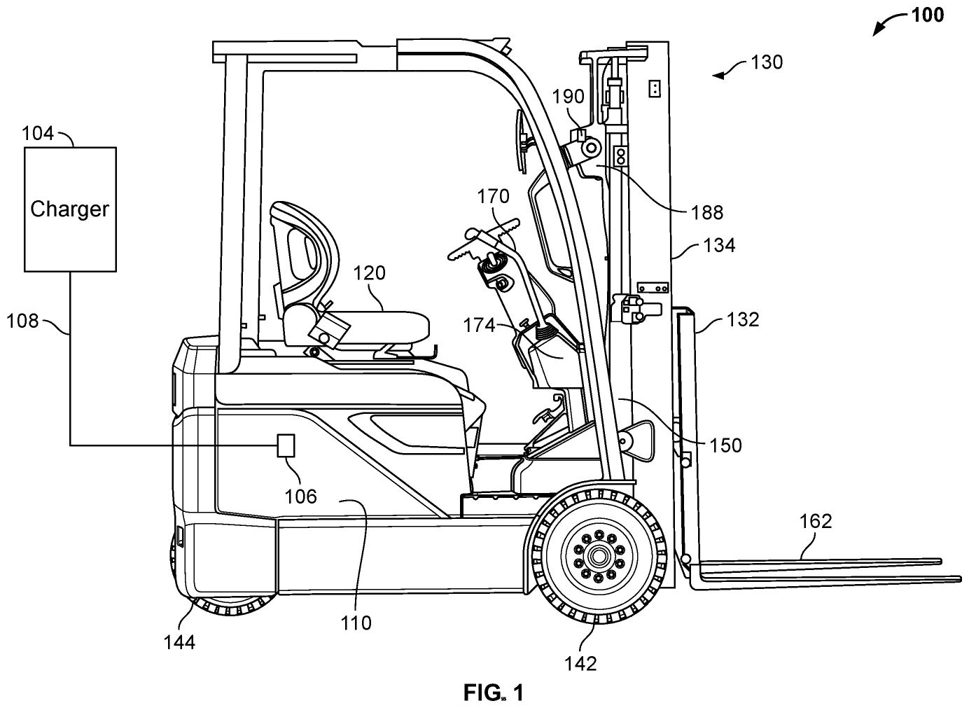

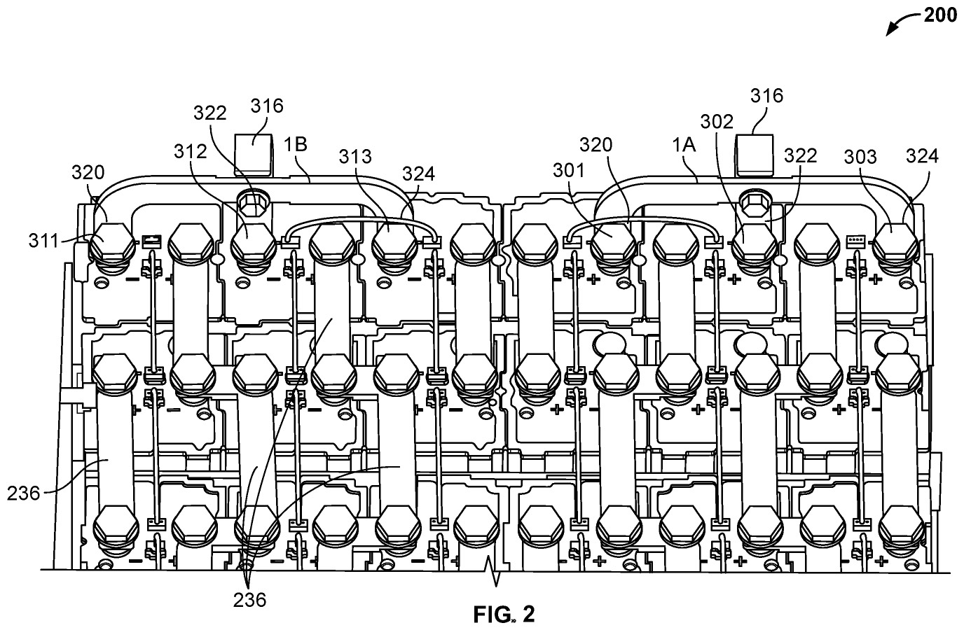

As explained above, it would be useful to provide an improved material handling vehicle. FIG. 1 illustrates a material handling vehicle 100 according to an embodiment. Specifically, the material handling vehicle 100 can be selectively coupled to one or more battery chargers 104 at a charging port 106 via a charging cable 108. In particular, the charging port 106 can be configured with one or more connection points to facilitate the electrical connection between a rechargeable battery pack 200 (see FIG. 2), which will be described further below, and one, two, three, or more battery chargers 104. In some embodiments, a single battery charger 104 can be configured to connect with multiple connection points of the charging port 106 and provide either multiple sources of charging current or a single source of charging current that is split between the multiple connection points. In some embodiments, two battery chargers 104 can each be separately connected to two connection points of the charging port 106.

The material handling vehicle 100 can comprise a vehicle body 110 having a driver's seat 120 associated with the body 110. A mast 130 can be provided in front of the driver's seat 120. The body 110 can further be connected to sets of wheels 142 and 144 at a front portion and at a rear portion of the body 110, respectively. The front wheels 142 can be used for steering the material handling vehicle 100. Alternatively, the rear wheels 144 can be used for steering, or both sets of wheels 142 and 144 can be used for four-wheel steering.

The mast 130 can be supported on a front axle so that the mast 130 can be tiltable in a forward or a backward direction with respect to the body 110. The tilting of the mast 130 can be accomplished by using a tilt cylinder 150 that is in communication with the mast 130. The tilt cylinder 150 can retract or protract, thereby tiling the mast 130. In some forms, the mast 130 can be a two-level slide mast that can include an outer mast 132 and an inner mast 134. The outer mast 132 can be supported on the body 110 in a tiltable manner, and the inner mast 134 can be supported on the outer mast 132 in a liftable manner. The inner mast 134 can further include support forks 162. Moreover, the outer mast 132 can be provided with one or more lift cylinders to lift or lower the inner mast 134 with the forks 162.

A control lever 170 can be provided near the driver's seat 120 for controlling the material handling vehicle 100. For example, the control lever 170 can be used to shift the material handling vehicle 100 into forward or backward movements. The control lever 170 can be coupled to a main controller 174, which includes a processor, a memory, and a display 188 onboard the body 110. A forward sensor 190 can be provided in front of the material handling vehicle 100 and can be provided in the form of an individual sensor, such as a camera, or a collection of sensors, including, but not limited to, laser scanners, accelerometers, gyro sensors, proximity sensors, radar sensors, lidar sensors, optical sensors (such as infrared sensors), acoustic sensors, barometers, thermometers, or other suitable sensors. The forward sensor 190 can also be coupled to the processor of the main controller 174.

The forward sensor 190 can be configured to detect conditions and obstacles in front of the material handling vehicle 100. In one non-limiting example, the forward sensor 190, together with the processor of the main controller 174, can determine that the material handling vehicle 100 is approaching a pallet, approaching another person, or approaching environmental hazards (such as a step or a stair). In some embodiments, the forward sensor 190 can be mounted at a location on the material handling vehicle 100 so that it can supplement a field of view of an operator whose field of view may be obstructed when the material handling vehicle 100 is carrying a load. The display 188 can be provided near the driver's seat 120 facing inwardly toward the driver when the driver is seated in the driver's seat 120 or outward away from the driver. The display 188 can be configured to show various data or images gathered or collected by different sensors onboard the material handling vehicle 100. The display 188 can be provided in the form of an LCD display, an OLED display, or other suitable display devices.

Although a counter-balance type material handling vehicle 100 is depicted, it should be appreciated that the material handling vehicle 100 may be provided in the form of any material handling vehicle or other vehicle used to transport materials. For example, the material handling vehicle 100 may be provided in the form of a reach truck, a stacker, a pallet truck, or an order picker, for example.

The material handling vehicle 100 is powered by the rechargeable battery pack 200, which is illustrated in FIG. 2. The battery pack 200 can include a housing, a plurality of battery modules, and a battery management system (BMS). The BMS includes a processor, a memory, and one or more sensors configured to determine current draw and voltage values. The battery modules can be provided in the form of lithium-ion batteries. The housing can include spacers, other structural plates, and other vibration dampening or cooling elements such as foam cushioning. The battery modules can be arranged and electrically coupled to one another to provide a nominal voltage value and a nominal capacity value. For example, in some forms, the battery modules are arranged and electrically coupled to provide a nominal voltage value of one of 36V or 48V. In some forms, the battery modules are arranged and electrically coupled to provide a nominal capacity value of one of 540 Ahr or 720 Ahr. Thus, the battery pack 200 is modular and can be provided with different arrangements and quantities of the battery modules. In some embodiments, the battery pack 200 and/or the battery modules themselves can include one or more sensors configured to sense one or more parameters of the battery pack 200 (e.g., charge status, temperature level, and the like) and/or the battery modules and communicate the sensed parameters to the BMS for aggregation, storage and or communicating the sensed parameters to other system components. For example, the battery pack 200 can include one or more of a temperature sensor, a voltage sensor, and/or a current sensor.

The BMS is coupled electrically, communicatively, or both with each of the battery modules, the display 188, and the main controller 174. The BMS serves as the central gatekeeper for charging the battery pack 200 and delivering power from the battery pack 200 to the material handling vehicle 100. For example, the BMS can be programmed to control battery charging by the charger 104. The BMS can also be programmed to control the delivery of power to one or more of the display 188, the main controller 174, the traction motors, and other components of the material handling vehicle 100.

Referring further to FIGS. 2-5B, the battery modules of the battery pack 200 can be electrically coupled to one another via a plurality of busbars 236, which are sized and shaped to accommodate various physical arrangements of the battery modules. The busbars 236 are comprised of an electrically conductive and rigid material such as copper, or more specifically, C110 ETP copper. In some embodiments, the battery modules are arranged and electrically coupled to form a battery circuit such that the battery pack includes three electrically parallel circuit branches, each branch having ten battery modules electrically coupled in series. Accordingly, there are three positive terminals 301, 302, 303 corresponding to the three parallel circuit branches on the positive side of the battery circuit and three negative terminals 311, 312, 313 corresponding to the three parallel circuit branches on the negative side of the battery circuit. As illustrated in FIG. 2, a three-pronged busbar 1A can be provided to couple the positive terminals 301, 302, 303 together, and a three-pronged busbar 1B can be provided to couple the negative terminals 311, 312, 313 together. Each of the busbars 1A, 1B includes one system-side terminal 316 and three battery-side terminals 320, 322, 324. In use, the BMS of the battery pack 200 can control whether the system-side terminals 316 of busbars 1A, 1B are electrically coupled to the material handling vehicle 100 to provide power to various components or whether the system-side terminals 316 of busbars 1A, 1B are electrically coupled to the charger 104 for charging the battery pack 200. This example busbar arrangement is non-limiting, and it should be appreciated that a variety of other battery circuit arrangements can be provided.

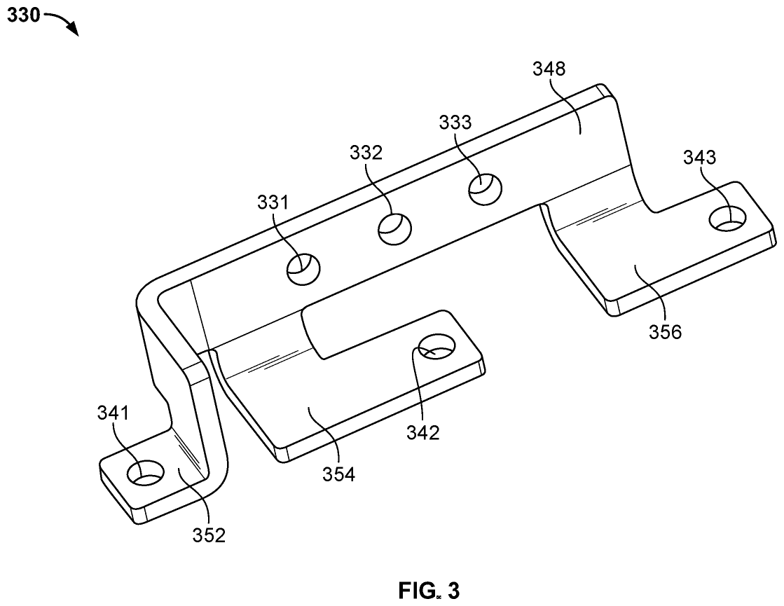

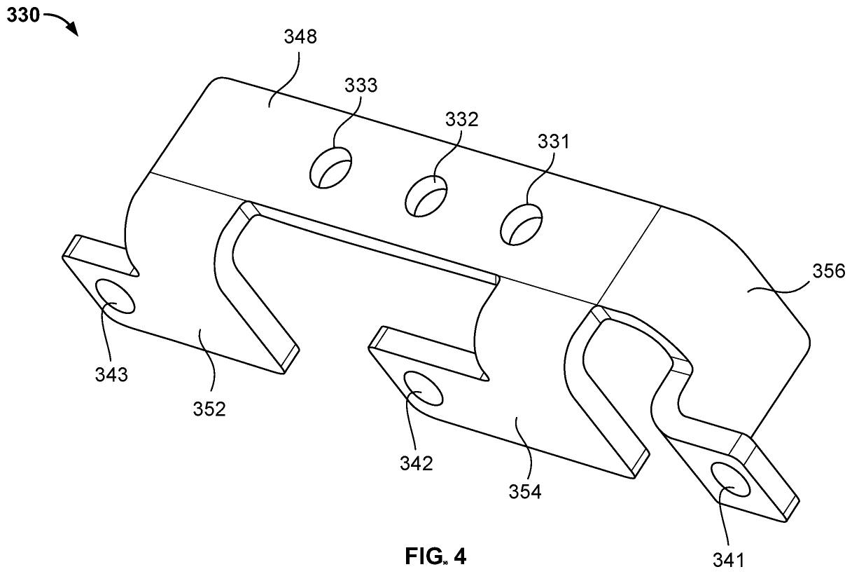

FIGS. 3 and 4 illustrate an equalizing busbar 330, which can be used in place of either or both of busbar 1A or busbar 1B in the battery pack 200. The equalizing busbar 330 includes three system-side terminals 331, 332, 333, three battery-side terminals 341, 342, 343, and is designed to provide an equal, or substantially equal distribution of current to and from the material handling vehicle 100 or the charger 104 and the parallel circuit branches of the battery pack 200. As is known in the art, the resistance of a conductor is a function of a conductor's length and cross-sectional area

$$R = ρ \frac{l}{a} .$$

Resistance R is equal to the resistivity p of the conductor material multiplied by the length l of the conductor and divided by the cross-sectional area a of the conductor. Accordingly, two conductors formed of the same material will have different resistance values if they have different lengths or cross-sectional areas. Because current flow favors the path of least resistance, more current will flow in a parallel circuit branch that has less resistance, and less current will flow in a parallel circuit branch that has more resistance. Here, the equalizing busbar 330 is designed to provide multiple current pathways with substantially equal resistance values, which is explained further below.

In some embodiments, the equalizing busbar 330 is provided in the form of a conductor having a core busbar body 348, and three legs 352, 354, 356. The core busbar body 348 can be provided in the form of a three-dimensional, rectilinear shape, such as a substantially rectangular prism. In some forms, the system-side terminals 331, 332, 333 are each formed as through-holes in the core busbar body 348. In some embodiments, the through-holes are circular in shape. Further, the center point of the circular profile of the through-holes of the system-side terminals 331, 332, 333 can be aligned with and distributed along a centered, longitudinal axis of the core busbar body 348. Additionally, in some forms, the distance from the system-side terminal 331 to the system-side terminal 332 is substantially equal to the distance from the system-side terminal 332 to the system-side terminal 333. In some embodiments, the center system-side terminal 332 is centered with respect to a short edge and long edge of the rectangular profile of the core busbar body 348.

Each of the legs 352, 354, 356 can also be provided in the form of a three-dimensional, rectilinear shape, such as one or more conjoined rectangular prisms. Further, each of the legs 352, 354, 356 can be provided in a substantially L-shaped form having two substantially rectangular segments. In some forms, one or more of the two “L” segments of each leg 352, 354, 356 can be partially or fully coated in a non-conductive material such as epoxy or rubber. Further, each segment of each of the legs 352, 354, 356, as well as the core busbar body 348 can be imparted with a substantially similar cross-sectional area, such as 6 mm by 28 mm. Each of the battery-side terminals 341, 342, 343 can be formed as a through-hole in a respective one of the legs 352, 354, 356. For example, the battery-side terminal 341 can be formed as a circular through-hole in the leg 352, the battery-side terminal 342 can be formed as a circular through-hole in the leg 354, and the battery-side terminal 343 can be formed as a circular through-hole in the leg 356. In some forms, each of the battery-side terminals 341, 342, 343, are positioned on a distal end of a distal leg segment of each of the respective legs 352, 354, 356. As shown in FIGS. 3 and 4, one or more of the legs 352, 354, 356, can be connected to the core busbar body 348 at an angle, which is explained further below.

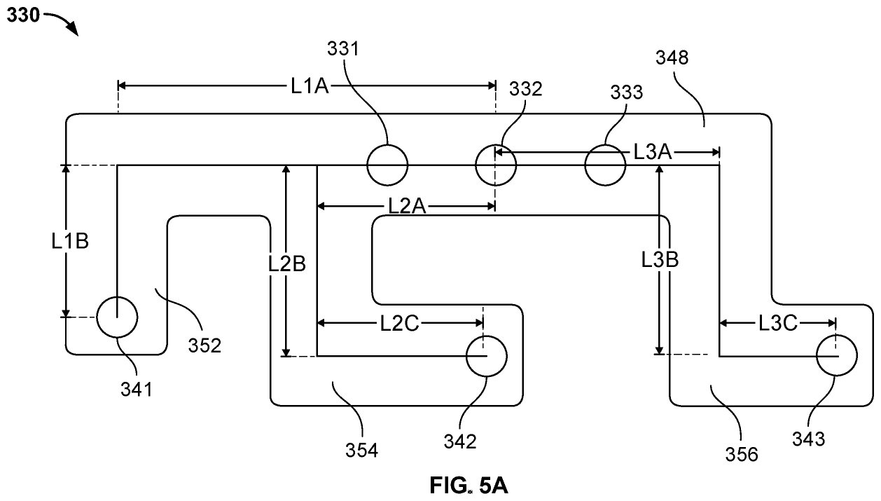

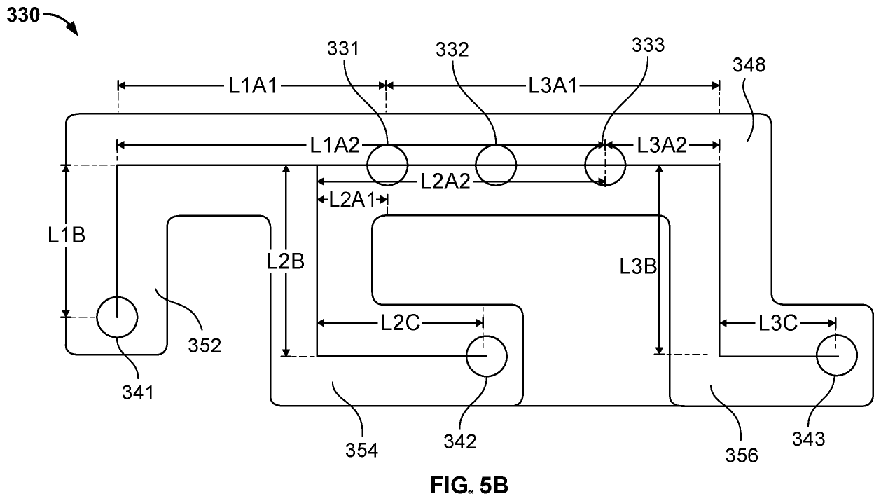

The equalizing busbar 330 can be manufactured from a flat sheet of material, such as by way of sheet metal stamping. Accordingly, during the manufacturing process, the equalizing busbar 330 is first provided in a flattened form, as shown in FIGS. 5A and 5B. As is evidenced by the curvilinear connection points between the core busbar body 348 and the legs 352, 354, 356, the legs 352, 354, 356 can be bent at an angle from the core busbar body 348, such as at about 90 degrees or at another angle value. Also, as shown by the leg 352, one or more of the legs 352, 354, 356 can include a second bend between a proximal leg segment and a distal leg segment. The second bend can also be at about 90 degrees, or at another angle. As a result, the through-holes of the system-side terminals 331, 332, 333 are positioned at a 90 degree angle with respect to the through-holes of the battery-side terminals 341, 342, 343. In some forms, a bottom face of each of the legs 352, 354, 356 are aligned on substantially the same plane as one another. Accordingly, the battery-side terminals 341, 342, 343 can be positioned on top of the battery pack 200, and the battery-side terminals 341, 342, 343 can be connected to the positive terminals 301, 302, 303 or the negative terminals 311, 312, 313 (see FIG. 2), while the system-side terminals 331, 332, 333 extend upward from the top of the battery pack 200 to be selectively electrically coupled to the material handling vehicle 100 or the charger 104 by the BMS.

In use, multiple electric current pathways are formed from the system-side terminals 331, 332, 333 to the battery-side terminals 341, 342, 343. For example, three current pathways from the center system-side terminal 332 to each of the battery-side terminals 341, 342, 343, are hereinafter defined as X1, Y1, and Z1 for simplicity of explanation. X1, Y1, and Z1 can have substantially equal length dimensions and substantially equal cross-sectional areas. Further, hereinafter, three current pathways from the left system-side terminal 331 to each of the battery-side terminals 341, 342, 343 are defined as X2, Y2, and Z2, and three current pathways from the right system-side terminal 333 to each of the battery-side terminals 341, 342, 343, respectively are hereinafter defined as X3, Y3, and Z3. Various geometric properties of each of the current pathways X1, Y1, Z1, X2, Y2, Z2, X3, Y3, and Z3 are defined in further detail below.

FIGS. 5A and 5B illustrate the equalizing busbar 330 in a flattened form to show the dimensional relationships between the current pathways mentioned above and segments thereof. Although the current pathways themselves are not labeled on FIGS. 5A and 5B, numerous current pathway segments, L1A, L1B, L2A, L2B, L2C, L3A, L3B, L3C, L1A1, L1A2, L2A1, L2A2, L3A1, and L3A2 are illustrated in FIGS. 5A and 5B, and the properties of the various current pathways, X1, Y1, Z1, X2, Y2, Z2, X3, Y3, and Z3 are defined below in reference to the current pathway segments for accuracy and simplicity of explanation. As illustrated in FIGS. 5A and 5B, it should be understood that the lengths of various current pathway segments are defined to start and/or end at the center points of the system-side terminals 331, 332, 333 and the battery-side terminals 341, 342, 343, extend along portions of the centered, longitudinal axis of the core busbar body 348, and extend along centered, longitudinal axes of each of the distal and proximal segments of each L-shaped leg 352, 354, 356.

Here, the current pathways X1, Y1, and Z1 correspond to the current pathways that are followed when the charger 104, or the material handling vehicle 100, is connected to the center system-side terminal 332, and the battery-side terminals 341, 342, 343 are coupled to the positive terminals 301, 302, 303 of the battery pack 200. For example, the current pathway X1 is defined as having a length of L1A+L1B, the current pathway Y1 is defined as having a length of L2A+L2B+L2C, and the current pathway Z1 is defined as having a length of L3A+L3B+L3C. The total length of each current pathway X1, Y1, and Z1 is substantially equal to others. Because the equalizing busbar 330 has a substantially uniform cross-sectional area and is formed of a substantially uniform material, the resistance values of each current pathway X1, Y1, and Z1 are, thus, substantially the same.

Because the resistances of current pathway X1, Y1, and Z1 are substantially equal, current is distributed substantially equally to and from each of the three positive terminals 301, 302, 303 and, consequently, to each of the three electrically parallel circuit branches of the battery pack 200. In this way, the battery modules are charged at a substantially equal rate. A secondary effect of equally distributing the charging current is that the equalizing busbar 330, the busbars 236, and the battery modules will experience a substantially uniform increase in temperature during charging. Accordingly, the increases in temperature due to current flow are distributed evenly throughout the battery pack 200, and the battery pack 200 experiences fewer instances of concentrated temperature spikes as compared to a battery pack that does not have a more even current flow distribution.

As shown in FIG. 5B, the current pathways X2, Y2, and Z2 correspond to the current pathways created when the charger 104, or the material handling vehicle 100, is connected to the left system-side terminal 331, and the battery-side terminals 341, 342, 343 are coupled to the positive terminals 301, 302, 303 of the battery pack 200. For example, the current pathway X2 is defined as having a length of L1A1+L1B, the current pathway Y2 is defined as having a length of L2A1+L2B+L2C, and the current pathway Z2 is defined as having a length of L3A1+L3B+L3C.

Further, the current pathways X3, Y3, and Z3 correspond to the current pathways created when the charger 104, or the material handling vehicle 100, is connected to the right system-side terminal 333, and the battery-side terminals 341, 342, 343 are coupled to the positive terminals 301, 302, 303 of the battery pack 200. For example, the current pathway X3 has a length of L1A2+L1B, the current pathway Y3 has a length of L2A2+L2B+L2C, and the current pathway Z3 has a length of L3A2+L3B+L3C.

The lengths of the current pathways X2, Y2, Z2, X3, Y3, and Z3 are dimensioned such that the combined length of the current pathways X2 and X3, the combined length of the current pathways Y2 and Y3, and the combined length of the current pathways Z2 and Z3 are all substantially equal to one another. As mentioned above, the equalizing busbar 330 is imparted with a substantially uniform cross-sectional area and is formed of a substantially uniform material. Therefore, the resistance of the current pathways X2+X3 is substantially equal to the resistance of the current pathways Y2+Y3 and the current pathways Z2+Z3. Accordingly, if the charger 104 or the material handling vehicle 100 is electrically coupled to both the left system-side terminal 331 and the right system-side terminal 333, the current delivered to/from the battery-side terminals 341, 342, 343 will be substantially equal. Thus, current will be distributed substantially equally to and from each of the three positive terminals 301, 302, 303 and to and from each of the three electrically parallel circuit branches.

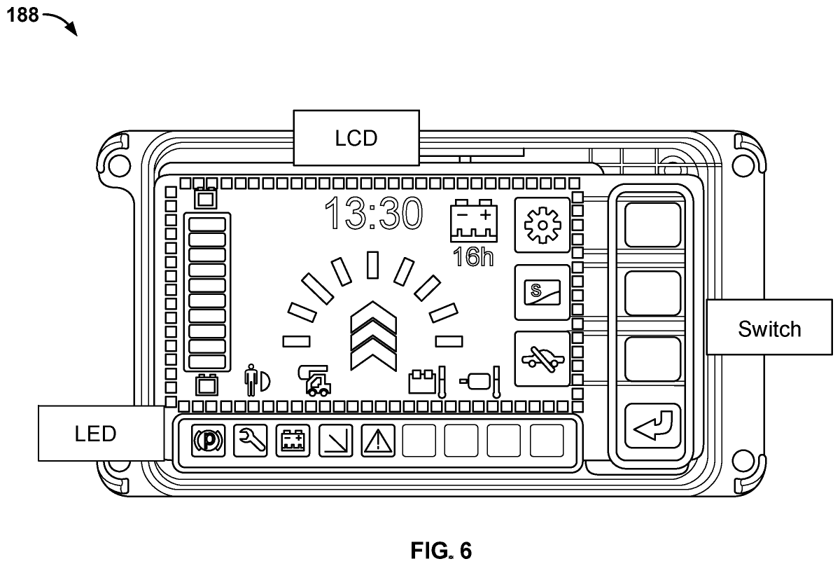

As mentioned above, the main controller 174 includes a display 188, which is shown in further detail in FIG. 6. The main controller 174 is communicatively coupled to the display 188, for example, via Controller Area Network (CAN bus) communication. The display 188 can comprise a high resolution color LCD screen that shows a number of different metrics relating to the material handling vehicle 100. The display 188 can display to the operator information such as the SOC value of the battery pack 200, the speed of the material handling vehicle 100, whether an object is detected in close proximity to the material handling vehicle 100, whether the inner mast 134 with the forks 162 is raised or lowered, whether the mast 130 is tilted, other vehicle information, or whether there are any malfunctions, error, or warnings associated with the material handling vehicle 100. Because the BMS is also communicatively coupled with the main controller 174, the display 188 can display error codes sent to the main controller 174 by the BMS. In this way, the operator can access all of the relevant information about the status of the material handling vehicle 100 and the battery pack 200 from the display 188.

Still referring to FIG. 6, example indications shown on the display 188 include a calendar clock, indication that a maximum speed limiter is active, indication that an overspeed alarm is active, indication that an auto speed control is active, indication that a lifting speed limitation is active, indication that a shock sensor is built in, a shock detection alarm, an indication that turn speed control is inactive, an operator presence indicator (LED), a parking brake indicator (LED), a height limit indicator, a low speed setting (turtle) indicator (LED), a spanner indicator (LED), an overheat warning indicator (LED), a battery overheat warning indicator, a battery fluid-level warning indicator, a battery discharge level indicator, a power select indicator, a power meter, a maintenance indicator, a rental hour meter indicator, a menu lock indicator, a battery fluid-level detection and vehicle performance control indicator, an auto speed control indicator, a lifting speed limitation indicator, a slope assist indicator, a wheel indicator, a mast tilt indicator, a direction indicator, a load meter, a battery temperature display, an odometer, a trip meter, a watt-hour meter, an over-discharge warning, a low battery charger warning, a low temperature warning, an overspeed alarm, a traveling power control level setting, and a load handling power control level setting, among others.

In some embodiments, the material handling vehicle 100 can also include audible indicators in addition to the visual indicators of the display 188. For example, a horn, buzzer, or other audible noise can be sounded when the forward sensor 190 detects that an object is in close proximity. In some forms, the audible noise can change pitch as the detected object gets closer to the forward sensor 190. In some forms, the audible noise can indicate other errors or malfunctions of the material handling vehicle 100 or the battery pack 200, and the audible noise can change depending on the increasing or decreasing severity of the error or malfunction. In some embodiments, the material handling vehicle 100 can also include one or more lights that can illuminate in solid light or other patterned lighting and in different colors to indicate specific malfunctions. For example, the light can pulse or blink in a specific pattern, and the light can illuminate in red, blue, yellow, green, orange, purple, or other colors in association with error codes communicated from the BMS or the main controller 174.

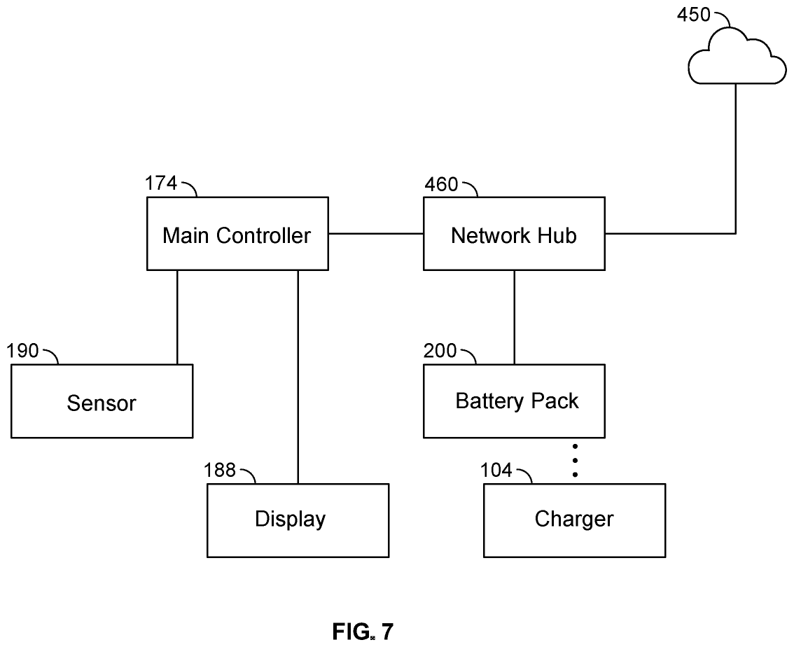

FIG. 7 illustrates that in some embodiments, the battery pack 200 and the main controller 174 can be communicatively coupled to a cloud server 450. A network hub 460 can be provided, which is communicatively coupled to the cloud server 450, the main controller 174, and the battery pack 200. Accordingly, temperature values and voltage values sensed by the battery pack 200, as well as other truck performance information, can be communicated to the network hub 460 to be wirelessly transmitted via Wi-Fi, cellular connection, or GPS modems to the cloud server 450 to be aggregated and/or processed. It is understood that the cloud server 450 can also be provided in the form of a local server or other remote network connected server. The network hub 460 can also receive data from the battery pack 200 associated with the charger 104. The network hub 460 can then transmit any and all the received data to the cloud server 450 wirelessly. The data can then be processed at the cloud server 450 or at a remote device to assess trends in battery voltage values, temperature values, SOC values, or state of health (SOH) values of the battery pack 200. Further, the raw or processed data can be accessed remotely via a remote device having access to the cloud server 450.

In some forms, over the air software updates, other programs, or data can be transmitted from a remote device that connects to the cloud server 450 to the network hub 460 or from the cloud server 450 itself to the network hub 460. In some forms, the communicative coupling between the battery pack 200 and the network hub 460, and between the network hub 460 and the main controller 174, is established via CAN communication. It is understood that other forms of wired and wireless communication can be provided in addition to or in place of CAN communication, such as RS-485 serial communication.

In some forms, over the air software updates can be used to customize various functional aspects of the material handling vehicle 100 and the BMS of the battery pack 200. For example, the temperature, voltage, and current data from the sensors of the battery pack 200 can be aggregated and assessed to understand trends associated with the material handling vehicle 100 and the battery pack 200. In addition, the SOH of the battery pack 200 can be monitored, and the SOH data can be transmitted to the cloud server 450 for aggregation and assessment. For example, the material handling vehicle 100 may be permitted to operate when the SOC value is below 20% in some applications, while in other applications, the material handling vehicle 100 may be prevented from operating at below 20% SOC or the lifting and/or driving functions of the material handling vehicle 100 may be limited. Also, in cooler climates or cold storage applications, faster charging rates might be acceptable due to natural heat dissipation. In contrast, the battery charging rates may need to be reduced in warmer climates. In some forms, GPS data or publicly available weather data can be used for more specific customization. Further, certain models of material handling vehicles may require less battery power, and thus, the low SOC cutoff threshold for the operation of the material handling vehicle 100 may be set to a lower value.

Other software or firmware of the main controller 174 and/or the BMS of the battery pack 200 can also be customized based on trends in battery SOH, different types/chemistries of batteries, different types or brands of battery chargers, different material handling vehicle models, or different climates and other weather conditions. For example, the main controller 174 can be programmed to limit the drive motor functions for the wheels 142, 144 and the hydraulic pump motor functions of the material handling vehicle 100 based on the temperature value of the battery pack 200 measured by the sensors of the battery pack 200.

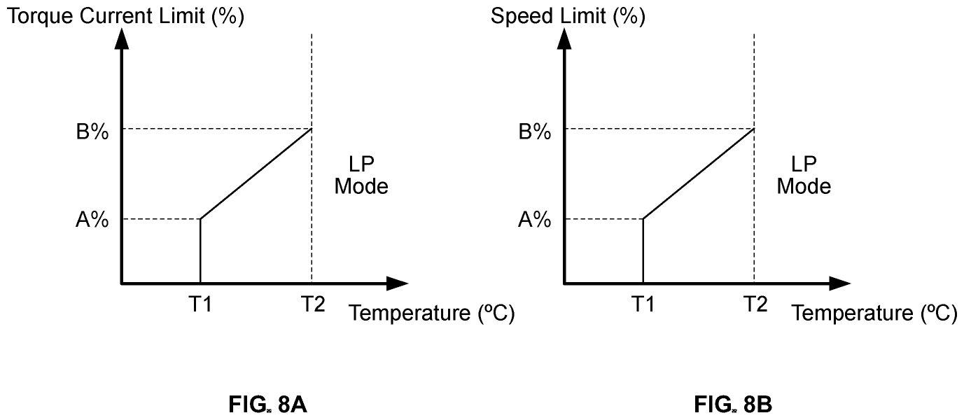

FIGS. 8A and 8B illustrate graphs of a torque limiting function and a speed liming function, respectively, according to an embodiment. For example, as shown in FIG. 8A, when the average temperature value of the battery pack 200, or the highest temperature value measured by the battery pack 200 is below a first temperature threshold T1, the drive motor functions and the hydraulic pump motor functions, such as the lifting of the support forks 162, can operate at up to 100% of their rated torque value. However, when the average temperature value of the battery pack 200, or the highest temperature value measured from the battery pack 200 exceeds the threshold T1, one or both of the drive motor functions and the hydraulic pump motor functions are limited by a percentage A % of the rated torque value. For example, once the temperature value of battery pack 200 exceeds T1, the motor functions of the material handling vehicle 100 can be reduced from 100% by A %, such as 20%, which limits the motor function to 80% of the rated torque value.

The percent of torque limiting can increase as a function of the temperature of the battery pack 200 as the temperature increases from TI to a second temperature threshold T2. In some forms, the torque limiting percentage increases linearly as a function of temperature up to the torque reduction percentage B %. In other forms, the torque limiting percentage can increase according to a polynomial function of temperature or another predefined relationship. Once the temperature of the battery pack 200 increases above T2, the main controller 174 is switched to a low power (LP) mode, whereby the power consumption of the material handling vehicle 100 is reduced significantly. The threshold T1 can be, for example, between about 55° C. to about 65° C., and the threshold T2 can be, for example, between about 60° C. to about 66° C. The torque limit reduction percentage A % can be about a 15% to about a 25% limit reduction, and the torque limit reduction percentage B % can be about a 40% to about a 55% limit reduction. The thresholds T1 and T2, and the torque limit reduction percentages A % and B %, can be customized based on trends analyzed at the cloud server 450 or a remote device with respect to battery SOH, different types/chemistries of batteries, different types or brands of battery chargers, different material handling vehicle models, and/or different climates and other weather conditions.

FIG. 8B illustrates the temperature-based speed limiting function, which is designed to limit the maximum speed achievable by the drive motor and/or the hydraulic pump motor. For example, when the average temperature value of the battery pack 200, or the highest temperature value measured from the battery pack 200 is below a first temperature threshold T1, the drive motor functions and the hydraulic pump motor functions can operate at up to 100% of their respective default maximum speed limit values. However, when the average temperature value of the battery pack 200, or the highest temperature value measured by the battery pack 200, exceeds the threshold T1, one or both of the drive motor functions and the hydraulic pump motor functions are reduced by a maximum speed limit value reduction percentage A % of the default maximum speed limit value. For example, once the temperature value of battery pack 200 exceeds TI, the motor functions of the material handling vehicle 100 can have a maximum speed limit value reduced from 100% by A %, such as 20%, which would limit the motor functions to 80% of the default maximum speed limit value.

The percent of maximum speed limit value reduction can increase as a function of the temperature of the battery pack 200 as the temperature increases from T1 to a second temperature threshold T2. In some forms, the maximum speed limit value reduction percentage increases linearly as a function of temperature up to the maximum speed limit value reduction percentage B %. In other forms, the maximum speed limit value reduction percentage can increase according to a polynomial function of temperature or another preprogrammed relationship. Once the temperature of the battery pack 200 increases above T2, the main controller 174 is switched to a low power mode, whereby the power consumption of the material handling vehicle 100 is reduced significantly. The threshold T1 can be, for example, between about 55° C. to about 65° C., and the threshold T2 can be, for example, between about 60° C. to about 66° C. The maximum speed limit value reduction percentage A % can be about a 15% to about a 25% limit reduction, and the maximum speed limit value reduction percentage B % can be about a 40% to about a 55% limit reduction. The torque limit percentages, A % and B %, can be customized based on trends analyzed at the cloud server 450 or a remote device with respect to battery SOH, different types/chemistries of batteries, different types or brands of battery chargers, different material handling vehicle models, and/or different climates and other weather conditions.

In other embodiments, other configurations are possible. For example, those of skill in the art will recognize, according to the principles and concepts disclosed herein, that various combinations, sub-combinations, and substitutions of the components discussed above can provide an improved material handling vehicle. The previous description of the disclosed embodiments is provided to enable any person skilled in the art to make or use the invention. Various modifications to these embodiments will be readily apparent to those skilled in the art, and the generic principles defined herein may be applied to other embodiments without departing from the spirit or scope of the invention. Thus, the invention is not intended to be limited to the embodiments shown herein but is to be accorded the widest scope consistent with the principles and novel features disclosed herein.

1. A busbar for a lithium ion battery pack, the busbar comprising:
a first system-side terminal;
a second system-side terminal;
a first battery-side terminal;
a second battery-side terminal;
a first electric current pathway having a first length value defined from the first system-side terminal to the first battery-side terminal;
a second electric current pathway having a second length value defined from the first system-side terminal to the second battery-side terminal;
a third electric current pathway having a third length value defined from the second system-side terminal to the first battery-side terminal; and
a fourth electric current pathway having a fourth length value defined from the second system-side terminal to the second battery-side terminal,
wherein a first sum value of the first length value and the second length value is substantially equal to a second sum value of the third length value and the fourth length value.

2. The busbar of claim 1, further comprising a third battery-side terminal.

3. The busbar of claim 2, further comprising a fifth electric current pathway having a fifth length value defined from the first system-side terminal to the third battery-side terminal.

4. The busbar of claim 3, further comprising a sixth electric current pathway having a sixth length value defined from the second system-side terminal to the third battery-side terminal.

5. The busbar of claim 4, wherein a third sum value is defined by the sum of the first sum value and the fifth length value.

6. The busbar of claim 5, wherein a fourth sum value is defined by the sum of the second sum value and the sixth length value.

7. The busbar of claim 6, wherein the third sum value is substantially equal to the fourth sum value.

8. The busbar of claim 1, wherein the first electric current pathway, the second electric current pathway, the third electric current pathway, and the fourth electric current pathway are all formed of the same material.

9. A busbar for a lithium ion battery pack, the busbar comprising:
a core busbar body including a first system-side terminal and a second system-side terminal;
a first busbar leg connected to the core busbar body and including a first battery-side terminal;
a second busbar leg connected to the core busbar body and including a second battery-side terminal;
a first length value defined along the core busbar body and the first busbar leg from the first system-side terminal to the first battery-side terminal;
a second length value defined along the core busbar body and the second busbar leg from the first system-side terminal to the second battery-side terminal;
a third length value defined along the core busbar body and the first busbar leg from the second system-side terminal to the first battery-side terminal; and
a fourth length value is defined along the core busbar body and the second busbar leg from the second system-side terminal to the second battery-side terminal,
wherein a first sum value of the first length value and the second length value is substantially equal to a second sum value of the third length value and the fourth length value.

10. The busbar of claim 9, further comprising a third busbar leg connected to the core busbar body and including a third battery-side terminal.

11. The busbar of claim 10, further comprising a fifth length value defined along the core busbar body and the third busbar leg from the first system-side terminal to the third battery-side terminal.

12. The busbar of claim 11, further comprising a sixth length value defined along the core busbar body and the third busbar leg from the second system-side terminal to the third battery-side terminal.

13. The busbar of claim 12, wherein a third sum value is defined by the sum of the first sum value and the fifth length value.

14. The busbar of claim 13, wherein a fourth sum value is defined by the sum of the second sum value and the sixth length value.

15. The busbar of claim 14, wherein the third sum value is substantially equal to the fourth sum value.

16. The busbar of claim 10, wherein the core busbar body, the first busbar leg, the second busbar leg, and the third busbar leg are all formed of the same material.

17. A busbar for a lithium ion battery pack, the busbar comprising:
a core busbar body including a system-side terminal;
a first busbar leg connected to the core busbar body and including a first battery-side terminal;
a second busbar leg connected to the core busbar body and including a second battery-side terminal;
a third busbar leg connected to the core busbar body and including a third battery-side terminal;
a first length value is defined along the core busbar body and the first busbar leg from the system-side terminal to the first battery-side terminal;
a second length value is defined along the core busbar body and the second busbar leg from the system-side terminal to the second battery-side terminal; and
a third length value is defined along the core busbar body and the third busbar leg from the system-side terminal to the third battery-side terminal,
wherein the first length value, the second length value, and the third length value are all substantially equal.

18. The busbar of claim 17, wherein the first busbar leg, the second busbar leg, and third busbar leg are each connected to the core busbar body at an angle.

19. The busbar of claim 18, wherein the angle is 90 degrees.

20. The busbar of claim 17, wherein the core busbar body, the first busbar leg, the second busbar leg, and the third busbar leg are each provided in the form of one or more rectilinear shapes.
